(19) United States
(12) Patent Application Publication
(10) Pub. No.: US 2008/0243373 A1
(43) Pub. Date: Oct. 2, 2008

(54) PORTABLE VEHICLE NAVIGATION DEVICE AND METHOD

(75) Inventors: Quan Cat, Farmington Hills, MI (US); Sari Rezzo, Farmington Hills, MI (US); Mike Rosinski, Farmington Hills, MI (US); Tetsuya Hori, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/694,602

(22) Filed: Mar. 30, 2007

(51) Int. Cl. G01C 21/00

(52) U.S. Cl. 701/207; 701/200

(57) ABSTRACT

A portable vehicle navigation device and method for use in a passenger vehicle. The navigation device is portable and calculates the vehicle speed rate from external global positioning signals and includes selected lock out of features and automatic volume adjustment.

### FIELD OF THE INVENTION

The present invention relates in general to navigation devices and methods of operation and more specifically, to portable navigation devices for use in passenger vehicles.

### BACKGROUND OF THE INVENTION

Electronic accessories for passenger vehicles have become more popular and are an important selling point for potential buyers of luxury vehicles. It has further become commonplace to combine previously separate personal electronic devices into one combined unit, for example the now popular devices that include personal digital assistants (commonly known as PDA's), cellular phones and digital cameras into one portable unit.

A popular accessory in luxury automobiles is built-in electronic vehicle navigation systems. These devices are typically integrated into the vehicle interior and are electronically interconnected to the vehicle's power system as well as the vehicle's speedometer and other sensory devices. Known built-in devices may include use of global positioning signals received from orbiting satellites (commonly referred to as GPS) or other vehicle location sensing systems to determine the geographic location of the vehicle and to assist in the navigation of the vehicle by the user. These devices typically allow inputs from the user, for example to select a destination, and the navigation device can output directions or other instructions through visual and/or audio displays to guide the user from their current location to the desired location.

Another increasingly popular luxury feature is the automatic adjustment of the volume of sound system music depending on the speed of the vehicle. For example, the volume of the in-vehicle stereo is automatically raised when the vehicle is traveling at a high rate of speed to compensate for engine and road noise and lowered when the vehicle comes to a stop at a traffic light.

A growing concern in the driving community is that drivers are distracted from driving by talking on cellular phones, changing or raising the volume of sound systems or viewing emails or other messages on one or more personal electronic devices. Known vehicle navigation devices have attempted to deter users from operating features of the device that require particular attention by the user while the vehicle is in motion. For example, built-in navigation devices may disable or lock out the use of features that require detailed inputs or attention from the driver necessarily taking the driver's attention away from the focus on the road. This locking out of features is usually initiated whenever it is sensed that the vehicle is in motion which may unduly restrict use at very low speeds.

These known navigation and luxury features suffer from several disadvantages. Known vehicle navigation systems are typically integrated into the vehicle interior and are not readily removed or portable. Known vehicle navigation devices further utilize existing vehicle power supplies and receive output from vehicle sensory devices such as the vehicle's speedometer. These electronic connections from the vehicle to the navigation device complicate the vehicle's wiring systems and harnesses. Further, the vehicle's sensory devices, for example to determine the speed that the vehicle is traveling, are dependent on many factors such as the size of the vehicle wheels which may not be as accurate as calculating the vehicle's speed through use of external global positioning signals. The built-in nature of the navigation devices and reliance on the vehicle's own sensing systems limit the accuracy and usefulness of vehicle navigation systems.

### SUMMARY OF THE INVENTION

It would therefore be advantageous to provide a vehicle navigation device that is portable and does not depend from the vehicle power supply or vehicle sensory devices or inputs such as the vehicle rate of speed as determined by the vehicle. It is further desireable to provide a portable navigation device that independently calculates the geographic position and vehicle speed rate that includes the safety feature of locking out selected user interface functions while providing the luxury feature of automatic volume adjustment.

In one embodiment of the invention, a portable navigation device includes a housing which is removeably securable to a vehicle, preferably in the interior passenger compartment and is readily accessible and viewable by a driver. The housing internally stores a positioning module for determining the geographical location of the navigation device positioned in the vehicle. In a preferred embodiment, the positioning module receives input from external global positioning satellite signals and outputs the calculated geographical position based on the received external signals.

The navigation device includes an internal speed calculation module positioned in the housing for calculating the land rate of speed the vehicle is traveling based on changes in the internally calculated geographic positions of the vehicle over time. The navigation device further includes a user interface controller which operates to selectively disable or lock out selected, predetermined functions when the calculated vehicle speed reaches predetermined levels. In a preferred embodiment, the user interface controller further automatically adjusts the volume of audible outputs to the user and the sensitivity of audible inputs from the user based on one or more factors including, the calculated speed of the vehicle, preprogrammed speed and noise data and the interior sound level in the passenger compartment as detected by an integrated microphone in the navigation device.

In a preferred use, the portable navigation device is removably mounted in the interior passenger compartment of the vehicle. On movement of the vehicle, the navigation device independently and repeatedly determines the geographic location of the vehicle and calculates the rate of speed. When the rate of speed reaches predetermined levels, selected user interface functions are disabled preventing the driver from using functions that distract the driver from the road. At the same or at different predetermined rates of speed, the audible volume of output signals from the navigation device to the user is adjusted to compensate for actually perceived or estimated sound levels in the passenger compartment.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic isometric view of the preferred portable navigation device;

FIG. 2 is a schematic drawing of the internal modules for determining the vehicle geographic location and rate of speed;

FIG. 3 is a schematic flow chart of the electronic inputs and outputs for the navigation device feature of disabling user interface functions when the vehicle speed rate reaches a predetermined speed threshold value; and

FIG. 4 is schematic flowchart illustrating the inputs and outputs for the navigation device feature of automatically adjusting the audible volume based on one or more inputs.

### DETAILED DESCRIPTION

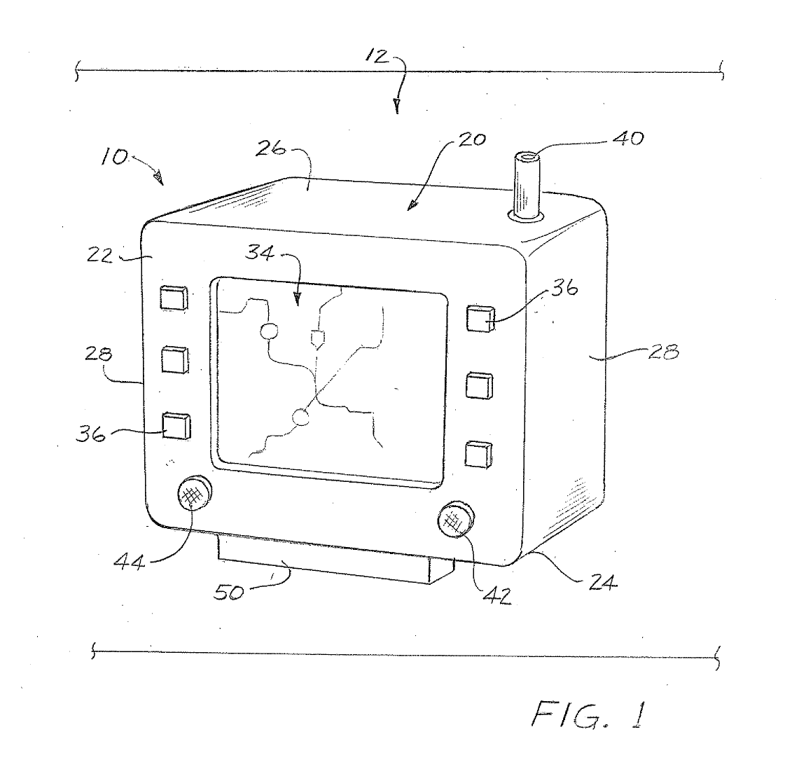

Referring to FIGS. 1-4 several embodiments of a portable navigation device (PND) for use in a passenger vehicle are illustrated. Referring to FIG. 1, a preferred embodiment of the portable navigation device 10 is illustrated. Navigation device 10 is most useful on a vehicle console 12, for example, on an instrument panel or center console.

Navigation device 10 includes a housing 20 having a first or user interface surface 22, a bottom surface 24, a top surface 26 and side surfaces 28 as generally shown. Housing 20 is preferably a self-containing outer shell for secured positioning of the user interface 22 and interior components that are described below. Housing 20 is preferably made from a molded polymer or elastomer that is designed for portable and active use indoors and outdoors and can be made from other materials known by those skilled in the art. Although shown as generally a rectangular shape, housing 20 can take any size, shape or configuration suitable for portable and active use as well as removeable placement in the interior passenger compartment of a vehicle.

Navigation device 10 includes on its user interface surface 22 a user display 34. User display 34 is used for the visual display of information to a user including text, graphics, pictures, videos, and other information useable by a driver. User display 34 is particularly useful in displaying maps and other graphical indicators to assist in guiding a user from a present to a preferred destination. User display 34 may be a liquid crystal display (LCD) or other type of visual display screen as known by those skilled in the art.

User interface surface 22 preferably includes control or function buttons 36 (six shown). Control buttons 36 are useful by the user to input information into navigation device 10, for example, choosing a destination or for changing the screen display to receive additional or alternate information from the navigation device 10. Although shown as six buttons 36, it is understood that control buttons 36 can take other forms for example, alpha numeric keypads, flush or recessed buttons, touch pads, touch screens, toggle switches and other manipulative controls as known by those skilled in the art.

Navigation device 10 further includes an antenna 40 shown as protruding from top surface 26 of housing 20. It is understood that antenna 40 can further be concealed within housing 20 depending on the features and desired performance of navigation device 10.

Navigation device 10 further includes a speaker 42 and microphone 44 preferably integrated into housing 20 positioned on user interface surface 22 as shown in FIG. 1. It is understood that speaker 42 and microphone 44 may be concealed within housing 20 or may be positioned on other surfaces or areas of housing 20.

In a preferred embodiment of use, a holder 50 is attached or integrated in vehicle console 12 as generally shown in FIG. 1. Holder 50 provides a secure and easily releaseable mounting attachment for navigation device 10 while navigation device 10 is mounted in the passenger compartment of a vehicle. Holder 50 can include a mechanical attachment, for example a removable locking engagement mechanism on the bottom surface 24 of navigation device 10 (not shown). In a preferred application, navigation device 10 may be recessed or mounted substantially flush in the instrument panel or other vehicle console panel 12 while maintaining easy removal for portability of device 10. In an alternate aspect, holder 50 can include other mounting mechanisms maintaining easy removal of navigation device 10 without the use of tools to maintain the portability of navigation device 10. In preferred aspect, on mounting engagement of navigation device 10 to holder 50, a signal is sent to the user interface controller described later so the navigation device 10 recognizes that the device is positioned in and secured to vehicle console 12.

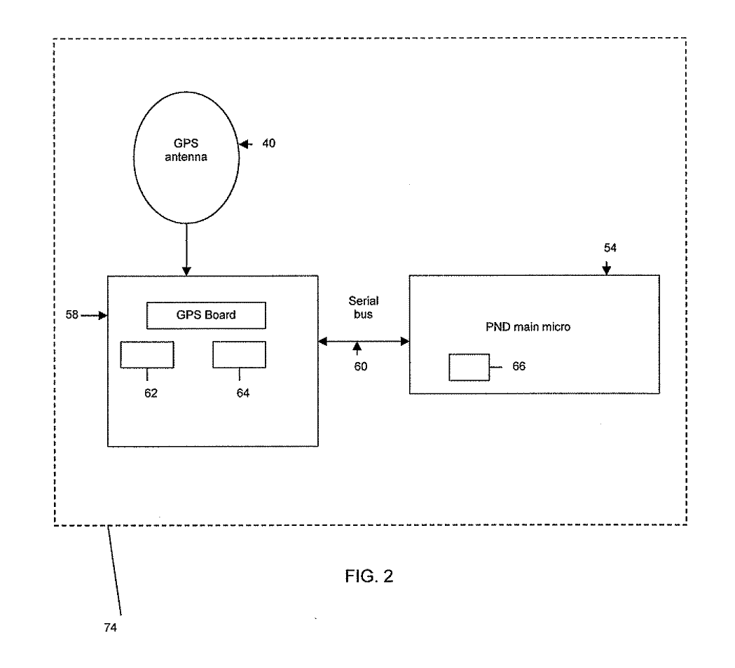

Referring to FIG. 2, the navigation device 10 includes a main microprocessor 54, a global positioning system (GPS) board 58, a serial bus 60, a positioning module 62, a land speed calculation module 64, and a user interface controller 66 as generally illustrated. These components are positioned within housing 20 and secured in a manner known by those skilled in the art. In a preferred embodiment as illustrated, GPS board 58 includes the positioning module 62 in electronic and/or digital communication with antenna 40.

In a preferred embodiment, antenna 40 receives external global positioning signals from GPS satellites and transfers those external signals to the positioning module 62. The positioning module 62 calculates the geographic position of the portable navigation device 10 positioned in the vehicle and generates an output signal of the geographic position based on the external signals to the GPS board 58.

The GPS board 58 preferably includes a land speed calculation module 64 positioned internally within housing 20 which receives the geographic position output signal from the positioning module 62. The speed calculation module 64 calculates the rate of speed the apparatus positioned in the vehicle is traveling based on changes in the calculated geographic position of the vehicle over a predetermined period of time. In a preferred embodiment, the calculated speed is accurate to approximately 0.1 miles per hour (MPH). It is understood that the accuracy can increase or decrease based on various factors and without deviating from the present invention.

In a preferred embodiment, the main microprocessor 54 polls the GPS board 58 for selected information from either or both of the positioning module 62 and the speed calculation module 64 approximately once every second through serial bus 60 as generally illustrated. The transfer of information through serial bus 60 may be made though a typical serial port such as SCI, RS232, I²C, and other methods known by those skilled in the art.

It is understood that the polling of information by microprocessor 54 from GPS board 58 may be on a shorter or greater interval and in alternate sequences as known by those skilled in the art without deviating from the present invention. It is further understood that board 58 and modules 62 and 64 may be combined, separate or alternately configured in ways known by those skilled in the art.

The navigation device 10 main microprocessor 54 preferably includes a user interface controller 66 also positioned within housing 20 which operates to receive signals from the positioning 62 and speed calculation 64 modules to control one or more features or functions of the user interface 22 based on the calculated rate of speed.

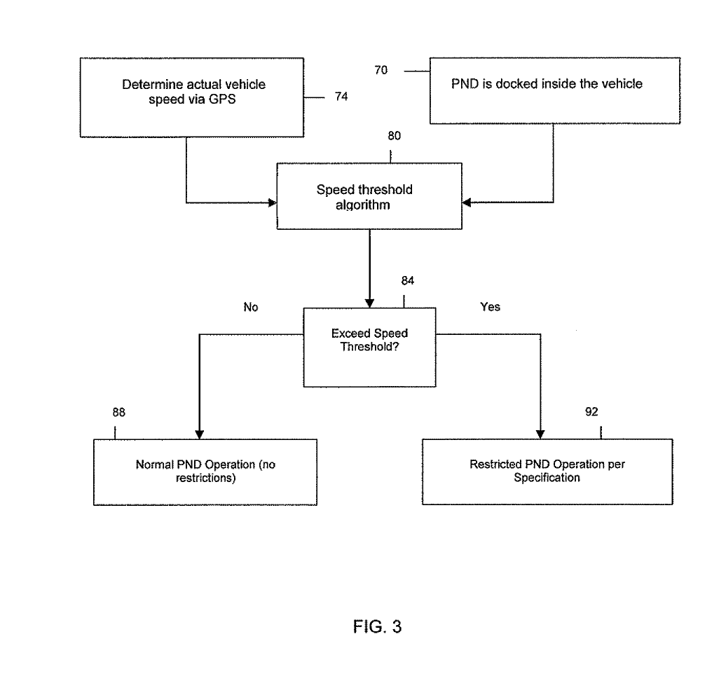

Referring to FIGS. 2 and 3, the portable navigation device 10 feature of disabling or locking out features or functions based on the calculated rate of speed is generally illustrated. The portable navigation device 10 includes a safety feature of locking out selected functions accessible through the user interface 22 by the user. As described previously, the portable navigation device 10 determines the vehicle rate of speed 74 based on direct receipt and calculation of external global positioning signals through antenna 40. The portable navigation device 10 further includes a sensor (not shown) which submits a signal 70 to the main microprocessor 54 that the navigation device 10 is positioned in a vehicle. In a preferred embodiment, the signal 70 is generated through engagement of the navigation device 10 with holder 50 as shown in FIG. 1. In an alternate embodiment, the signal can be generated through a manual switch or button 36 on the user interface 22 by the user.

In a preferred embodiment, a speed threshold algorithm 80 is preprogrammed in the main microprocessor 54 and through the user interface controller 66 it is determined whether the calculated vehicle speed through the external global positioning signals has reached a first predetermined threshold value 84 as best seen in FIG. 3. If the determined vehicle speed 74 exceeds the first predetermined value 84, the user interface controller 66 and/or microprocessor 54 initiates signals to disable selected features or functions of the navigation device 10 based on parameters specified by the manufacturer or user.

In a preferred embodiment, the selected features that are disabled or locked out from use by a user may include: destination entry wherein the user enters a specific address; so-called deep points of interest searches by the user that are more than three display menus away; so-called deep list/searches by the user wherein a user typically scrolls through a list or searches that are either more than three menus away or contain lists of more than five items per display screen; a deep menu item wherein user access to menus are more than three menus away; and display of videos and/or pictures.

In a preferred embodiment, and for exemplary purposes only, features that would not typically be locked out depending on the determined calculated speed of the vehicle may include: pre-programmed home locations and addresses; recent points of interest searches and addresses; manual volume and brightness adjustment of the user interface 22; and route stop and other user preferences.

In a preferred embodiment, the first predetermined value or threshold 84 wherein one or more of the above-identified selected features are disabled or locked out, would occur when the navigation device 10 detects vehicle movement or a rate of speed, i.e. it is calculated that the vehicle is in motion. In an alternate aspect, and due to the anticipated increased accuracy of calculating the vehicle speed rate based on external global positioning radio signals received directly by device 10, the first predetermined threshold to lock out user interface functions may extend into where the vehicle is in motion and traveling at a low rate of speed and where use of such functions does not distract the driver. Further, a second or multiple predetermined threshold values may be employed wherein useful features are enabled at low speeds, but disabled at higher speeds. It is understood that the predetermined lock out threshold values and the selected user interface features to be locked out may be varied without deviating from the present invention.

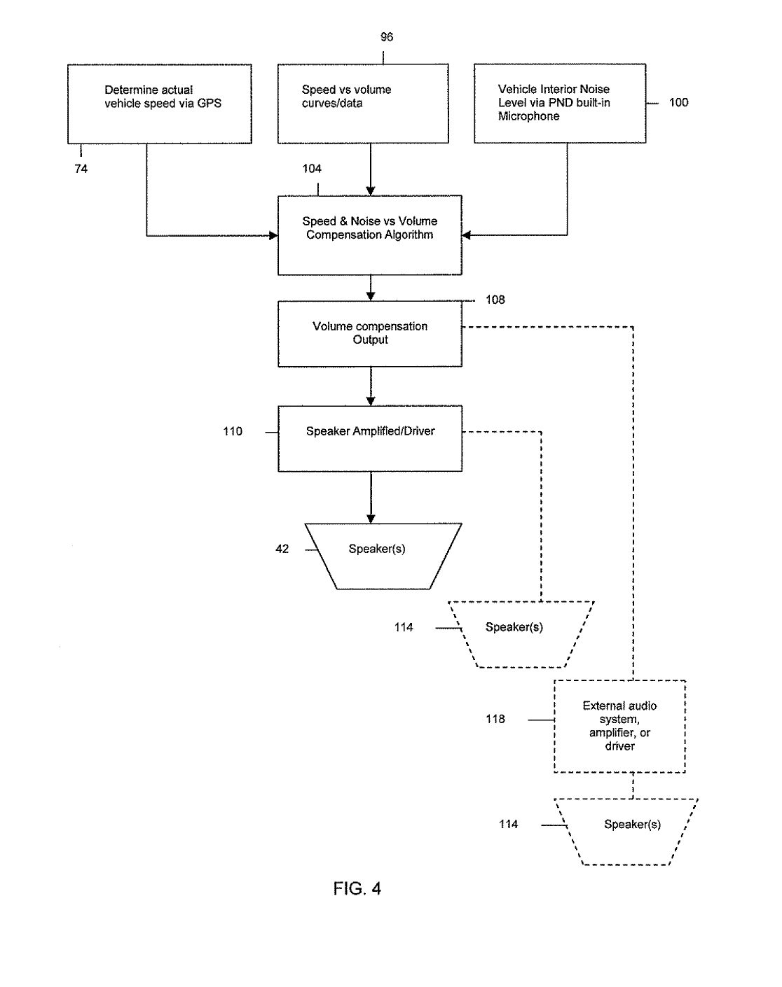

Referring to FIGS. 2 and 4, the portable navigation device 10 feature of automatic volume compensation adjustment based on various inputs is generally illustrated. As previously described, the navigation device 10 will calculate the vehicle rate of speed 74 through receipt and calculation of global positioning signals through the positioning 62 and land speed calculation modules 64.

Further, in a preferred embodiment, it is contemplated that empirical speed sensitive volume (SSV) data tables and curves may be pre-programmed into microprocessor 54 and used as an input 96, alone or in combination with other inputs, to a volume compensation algorithm described below. The empirical data and/or curves may consist of incremental volume steps or ranges depending on the calculated speed of the vehicle. For example, for a range of vehicle speeds from 0 to 29 miles per hour (MPH), the volume adjustment or compensation may be zero, i.e. the volume remains at its preset or normal volume. Between a vehicle speed range of 30 to 40 MPH, the volume may be increased or compensated by a predetermined level. From 40 to 50 MPH, the volume adjustment or compensation may be incrementally raised higher by a predetermined amount and so on. A similar incremental downward adjustment may be made by the same or similar pre-programmed data or curve.

In an alternate embodiment, different data sets or curves could be pre-programmed over the same vehicle speed ranges to accommodate the preferences of the user. For example, in a low volume adjustment setting, the volume adjustment increment could occur at 60 MPH and include relatively small adjustments in predetermined ranges above that. In a middle or high volume adjustment setting, the first incremental volume adjustment could occur at 20 MPH and at a range beginning at 60 MPH the volume would be at a higher level than that at 60 MPH while on the low volume adjustment setting.

It is understood by those skilled in the art that the above specifications are exemplary in nature and that different values and settings may be used without deviating from the present invention.

Referring to FIG. 4, a third input signal 100 of the level of sound or noise in the passenger vehicle compartment as detected by microphone 44 may be used.

In a preferred embodiment, as generally illustrated in FIG. 4, one or more of the inputs of determined vehicle speed 74, preprogrammed speed versus volume curves 96, or sound levels 100 in the vehicle passenger compartment are sent to a volume compensation algorithm 104 preferably handled by the main microprocessor 54. One or more of these inputs are evaluated in the preprogrammed volume compensation algorithm 104 to determine whether compensation of the audible level of output from the navigation device 10, for example audible directions to a user, are calculated.

On evaluation on the above inputs by the compensation algorithm 104, a volume compensation output signal 108 is issued to a speaker/amplifier/driver 110 and on to one or more audio volume components or speakers 42 on the user interface 22 as shown in FIG. 1.

In an alternate embodiment, the volume compensation output signal 108 may be sent directly, or alternatively to external audio amplifies drivers and/or speakers 114 and 118 as shown in FIG. 4. In a preferred embodiment wherein external speakers are used, a device or module (not shown) is used to temporarily mute alternative signals directed through the speakers, for example music, so that only the audible signals generated from the navigation device 10 are heard by the user. The specific module and integration into navigation device 10 may be by methods known by those skilled in the art.

In use, the portable navigation device 1, based on one or more inputs 74, 96, and 100, automatically adjusts the audible volume of the navigation device 10 to compensate for the sound level in the passenger compartment based on the determined vehicle rate of speed 74, predetermined speed versus audible volume curves 96 or detection of interior noise of vehicle 1 00. It is understood that one or more of these inputs may be combined and evaluated by the compensation algorithm 104 and thereafter output and controlled by user interface controller to automatically adjust the volume for convenience of the user. In an alternate embodiment, the sensitivity of verbal commands provided by a user to the navigation device 10 through audio volume component or microphone 44 may also be automatically adjusted to compensate for environmental sound levels.

The present portable navigation device provides numerous advantages in the portability of vehicle navigation devices using external global positioning signals to determine the rate of speed of the vehicle without using the traditional integrated vehicle speed sensors. The portable navigation device 10 having the feature of locking out selected functions from use by a user based on the more accurate determination of vehicle speed through use of an external global positioning signals which provides flexibility in the predetermined value wherein one or more of the features are disabled. The navigation device 10 further provides the features for automatically adjusting the audible volume and sensitivity of the device based the calculated speed of the vehicle and other inputs by the navigation device 10 itself.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. (canceled)

2. (canceled)

3. (canceled)

4. (canceled)

5. (canceled)

6. (canceled)

7. The navigation apparatus of claim 12 wherein the disabled first interface function is one of a user destination input, a function that requires a display of more than three interface menu screen displays from the current interface screen display and display of pictoral images through the interface screen display.

8. A vehicle comprising:
an interior console panel; and
a portable navigation device having a housing, a receiver adapted to directly receive external radio signals and calculate the geographic location and land rate of speed of the vehicle based on the radio signals, a user interface operable to receive input from a user and output information to a user; a portable power supply, and an interface controller operable to control interface functions based on the determined vehicle rate of speed; and
a sensor to detect if the navigation device is positioned within the vehicle.

9. The passenger vehicle of claim 8 wherein the portable navigation device user interface further comprises audio automatic adjustment including an audio component wherein the interface controller automatically adjusts at least one of an input sensitivity and an output volume of the audio component based on the determined speed of the vehicle.

10. The passenger vehicle of claim 9 wherein the audio automatic adjustment is calculated by a volume compensation algorithm in the portable navigation device based on predetermined vehicle speed versus vehicle interior audio volume ratios.

11. The passenger vehicle of claim 9 wherein the audio automatic adjustment is calculated by a volume compensation algorithm stored internally in the portable navigation device based on a determined interior audio volume in the vehicle.

12. The passenger vehicle of claim 8 wherein the interface controller is operable to selectively disable a first interface function based on a first predetermined vehicle speed value.

13. The passenger vehicle of claim 12 wherein the first predetermined speed value is greater than zero miles per hour.

14. (canceled)

15. (canceled)

16. (canceled)

17. (canceled)

18. (canceled)

19. (canceled)

20. (canceled)

21. The vehicle of claim 8 wherein the sensor for detecting whether the navigation device is positioned in the vehicle is a component of the navigation device and is in electronic communication with a microprocessor.

22. The vehicle of claim 21 wherein the navigation device sensor is operable to send a signal to the navigation device indicating the navigation device is positioned in the vehicle upon input of a signal to the sensor from at least one of the vehicle and a manual input by the user through the user interface.

23. The vehicle of claim 8 wherein the navigation device is operable to output audio signals to the vehicle for transmission of navigation device audio signals to at least one audio speaker mounted in the vehicle.

24. The vehicle of claim 8 further comprising a navigation device holder connected to the console for secure and removable engagement of the navigation device to the vehicle.

25. The vehicle of claim 24 wherein the holder is in electronic communication with at least one of a vehicle power source and a vehicle audio system.

26. The vehicle of claim 12 wherein the interface controller is operable to selectively disable a second interface function based on a second predetermined vehicle speed greater than the first predetermined vehicle speed value.

27. A vehicle comprising:
an interior console panel having an accessory holder; and
a portable navigation device having a housing; removeably engaged with the accessory holder; a receiver adapted to directly receive external radio signals and calculate the geographic location and land rate of speed of the vehicle based on the radio signals, a user interface operable to receive input from a user and output information to a user; a portable power supply, arid an interface controller operable to control interface functions based on the determined vehicle rate of speed.

28. The passenger vehicle of claim 27 wherein the interface controller is operable to selectively disable a first interface function based on a first predetermined vehicle speed value.

29. The passenger vehicle of claim 28 wherein the first predetermined speed value is greater than zero miles per hour.
